(19) United States
(12) Patent Application Publication
(10) Pub. No.: US 2002/0122962 A1
(43) Pub. Date: Sep. 5, 2002

(54) Anti-reflection UV-blocking multilayer coatings having a thin film layer having cerium oxide, silicon dioxide and transition metal oxides

(75) Inventors: Nanning J. Arfsten, Moorestown, NJ (US); James F. Gavlas, Mercerville, NJ (US); Brandon Thomas Steel, Woodbine, NJ (US); Kerrin Arfsten, Moorestown, NJ (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Denglas Technologies, L.L.C.

(21) Appl. No.: 09/948,880

(22) Filed: Sep. 7, 2001

Related U.S. Application Data
(63) Continuation of application No. PCT/US01/04495, filed on Feb. 12, 2001.
(60) Provisional application No. 60/181,726, filed on Feb. 11, 2000.

(51) Int. Cl. B32B 9/00; B05D 5/06; B32B 19/00

(52) U.S. Cl. 428/697; 427/164; 427/169

(57) ABSTRACT

An antireflective multilayer coating including a thin film optical coating as well as a method for producing such a coating are provided. The thin film optical coating includes a layer of sol-gel derived cerium oxide, silicon dioxide, and at least one oxide of a transition metal selected from Group IIIB through Group VIB of the Periodic Table which is capable of providing a refractive index of at least about 1.90. The thin film may optionally include colloidal gold particles. A method is provided for producing a thin film optical coating including a layer of sol-gel derived cerium oxide, silicon dioxide, and at least one oxide of a transition metal selected from Group IIIB through Group VIB of the Periodic Table by immersing a substrate in a solution comprising cerium nitrate hexahydrate, an alcohol and a chelating agent, withdrawing the substrate from the solution and heat treating the coated substrate to form the metal oxides.

### CROSS-REFERENCE TO RELATED APPLICATION

This application claims the benefit of U.S. Provisional Application No. 60/181,726, filed Feb. 11, 2000.

### BACKGROUND OF THE INVENTION

Thin film optical coatings can be used to alter a substrate's optical properties. For example, the reflection of light which occurs at the interface of two different materials may be altered by applying a thin film optical coating to a surface at such an interface. Additionally, the transmission of light can be reduced by an absorbent optical coating or the transmittance/absorbance of specific wavelengths can be enhanced.

It is often desirable to reduce the percentage of visible light which is reflected at an interface and increase the transmittance of visible light, thus reducing glare associated with the reflection of visible light. Anti-reflection thin film optical coatings for such purposes have numerous applications including, for example, windows, lenses, picture frames and visual display devices such as computer monitors, television screens, calculators and clock faces.

Generally, the reflection of light occurs at the interface of two materials which have different indices of refraction, for example, glass and air. Air has an index of refraction, n, of approximately 1.00 and glass generally has an index of refraction of approximately 1.51, so that when light which was previously travelling through air becomes incident upon a glass surface, some of the light is refracted (bent) and travels through the glass at an angle different from the angle of incidence, and some of the light is reflected. Theoretically, in order to minimize the amount of light which is reflected from a glass surface, it would be ideal to coat the glass with a material having an index of refraction which is the square root of 1.51, which is the index of refraction of glass. However, there are very few durable materials which have such a specific index of refraction (i.e., 1.2288).

In order to overcome the problem created by the lack of durable materials having the requisite index of refraction, thin film coatings having multilayer designs have been developed. Prior multilayer anti-reflection coatings have included two, three, four and more layers. By using multilayer coatings with layers that have high, medium and low indices of refraction, in various combinations and orders, prior coating systems have been able to reduce the reflection of visible light at air/substrate interfaces to negligible percentages. However, each layer in a multi-layer coating system increases the overall cost of the coating system.

There are many different examples of multilayer coating systems that have previously been used. Two, three and four layer anti-reflection coatings are known and are described, for example, in H. A. Macleod, “Thin Film Optical Filters,” Adam Hilger, Ltd., Bristol 1985. The coatings are designed to provide specific indices of refraction for different applications to deliver required optical properties. Indices of refraction are material constants. The index of refraction of a material, the amounts of a material, the combinations of materials and layer thicknesses all affect the optical properties of the resulting system. One such system commonly used is a “three-layer low” multilayer coating which has a medium index of refraction layer (“M-layer”) coated on the substrate, the M-layer having an index of refraction (“n”) of from 1.60 to 1.90, a high index of refraction layer (“H-layer”) coated on the M-layer, the H-layer having an n greater than 1.90, and a low index of refraction layer (“L-layer”) coated on the H-layer, the L-layer having an n less than 1.60, (thus providing an overall M/H/L structure). Other designs include bilayer coatings which generally have an M/L design which includes an inner M-layer and an outer L-layer. Such designs are useful, for example, with laser optic applications. Four layer systems are also known which generally have an H/L/H/L design and include an inner H-layer coated with an L-layer followed by a further H layer and L layer. Such coatings are typically used for technical applications which need to accommodate a somewhat greater amount of light passing through the coating then for standard applications.

Materials which are currently used in thin film optical coatings as layers having a high index of refraction include titanium oxide, hafnium oxide and other transition metal oxides. However, in order to produce durable coating layers of these high index of refraction materials, it is often necessary to use expensive techniques such as vacuum evaporation or sputtering. The cost of the equipment used in such application processes can often create an economically unfeasible approach to producing such coatings.

Other techniques by which layers of thin film optical coatings have been applied to substrates include the use of sol-gel technology. A common sol-gel technique includes the application of a solution to a substrate, with the subsequent conversion of an oxide precursor contained within the solution, to an oxide on the surface of the substrate. This method generally involves the removal of water by heat treatment. An alternative and more recently adapted technique of sol-gel chemistry involves the application of a colloidal suspension (sol) of a chemically converted oxide to a substrate with the subsequent evaporation of the suspending medium at room temperature. The first method is usually preferable due to the difficulties which may be encountered during the preparation of adequate colloidal suspensions.

The use of sol-gel chemistry in applying thin film optical coatings is desirable due to the prohibitive capital expenses associated with vacuum deposition equipment.

When a sol-gel method is used to coat a substrate, the coating that is deposited generally requires a final heat cure to convert the coating into the desired oxide. A common cure temperature used in sol-gel applications is approximately 400° C. There are many materials that have melting or decomposition points below 400° C., including, for example, certain plastics and other polymeric resins. Thus, thin film optical coatings cannot be coated on a large class of materials (i.e., those with melting points below 400° C.) using conventional sol-gel processes. Currently, heat-sensitive materials are coated by vacuum deposition.

Within the picture frame trade there is strong interest in materials that help to protect the framed artwork. Exposure to ultraviolet radiation is known to be damaging to paints and inks, as well as to the commonly used substrates such as paper, wood, canvas, and other fabrics. As a result, various glazing materials have been developed to block transmission of ultraviolet light.

When plastics (i.e., acrylics or polycarbonates) are used for glazing, they are frequently modified by inclusion of an ultraviolet (“UV”) absorbing material. A wide variety of organic UV absorbers have been developed to stabilize and protect the plastics themselves from degradation by ultraviolet radiation. These materials are designed to absorb light in the 300 to 400 nm region, while being essentially transparent to visible light which has wavelength greater than about 400 nm. Plastics containing UV absorbers do an adequate job of blocking ultraviolet light but their general acceptance in the trade is hindered by their susceptibility to mechanical damage (e.g., abrasion and scratching) and by their tendency to build and hold static electric charge.

Glass is the preferred glazing material due to its durability and generally superior appearance. However, picture framing glass (soda-lime float glass) in standard 2 mm thickness blocks only about 40% of the light from 300 to 400 nm. This is in contrast to the above-mentioned UV blocking plastics, which filter out in excess of 97% of the ultraviolet light.

Several approaches have been taken to produce a UV blocking picture frame glass. Inclusion of an organic UV absorber within the glass itself is not an option, since these organic materials decompose at the temperatures at which glasses are formed.

An early approach was to produce a thin, flexible plastic film which contained a UV absorber, and which was provided with an adhesive material on one surface. This type of product, while effective at blocking UV radiation, has a poor appearance when applied to glass, due to surface irregularities caused by variations in film thickness and variations in thickness of the adhesive layer. In addition, these films are soft and are even more easily damaged than the acrylic and polycarbonate products that they were intended to replace.

A refinement of this approach resulted in a product having a UV absorbing plastic film applied to one side of the glass as part of the manufacturing process. This coated glass product has good UV blocking properties and better appearance than the adhesive backed films, but still has small-scale surface irregularities that distort images viewed through the glass. The UV blocking film is also still subject to mechanical damage.

The best cosmetic appearance is achieved by laminating a plastic, typically polyvinyl butyral, containing a UV absorber, between two pieces of glass. This product has good durability, since the plastic is protected by the glass, and has the added advantage of being shatter resistant, which is of importance in the field of conservation framing. However, the extra weight of the second piece of glass is a disadvantage.

Conservation framers are also interested in products that permit optimum viewing of the framed artwork. The best glazing material for this purpose is glass with anti-reflection coatings applied to both surfaces. Typically, a product of this type will reduce reflection of visible light from 8% for uncoated glass to about 1%, while increasing transmission of visible light from about 90% for uncoated glass to about 97%. An antireflective glass that also blocks ultraviolet light is therefore highly desirable.

To date, two systems have been developed which address this need. The first of these, available from Denglas Technologies, is a laminated, UV blocking glass, such as that mentioned above having two pieces of glass with a UV film laminated between the pieces of glass, and which has antireflective coatings applied to the outside surfaces of the two pieces of glass. The second, available from Truview as Museum Glass is a single sheet of glass with a UV blocking film applied to one surface and antireflective coatings applied to both surfaces. However, such system still uses a UV film which is subject to the various disadvantages as noted above. These products have much the same advantages and disadvantages as their uncoated counterparts. In addition, the multi-step processes required result in high manufacturing costs for both products.

Certain metal oxides, notably CeO₂ and TiO₂, are capable of absorbing ultraviolet light while being highly transmissive with respect to visible light. Both of these oxides have refractive indices in excess of 2.00, and can serve as high index layers (H layers) in thin film optical systems. However, in a typical three layer antireflective coating, optimized for the visible, the physical thickness of the H layer is on the order of 100 nm. Unfortunately, neither of these oxides has a high enough extinction coefficients in the 300-400 nm range for a 100 nm thick layer to provide adequate UV blocking for conservation framing purposes.

Cerium (III) nitrate hexahydrate dissolved in alcohol will reportedly form a cerium (IV) oxide layer of good optical and mechanical quality. CeO₂ films so formed are reported to have strong absorption in the ultraviolet while being highly transmissive in the visible. See H. Schroeder, “Oxide Layers Deposited From Thin Films,” Physics of Thin Films, 5, pp 87-141, (1969).

As such, attempts have been made by others to produce CeO₂ films from solution, however, such attempts have been generally unsuccessful, except in cases where the CeO₂ was embedded in a matrix of some material which tends to readily form high quality films, such as SiO₂ or TiO₂. See M. A. Sainz, A. Duran and J. M. Fernández, “UV Highly Absorbent Coatings with CeO₂ and TiO₂,” Non-Cryst. Solids, 121, 315-318, (1990). Sainz reported that in SiO₂—CeO₂ systems it was possible to obtain good coatings only if the CeO₂ content was kept below 10 mole percent. Above this value, opalescence was observed in the coatings. In the presence of TiO₂, higher contents of CeO₂ could be incorporated as long as the molar ratio of TiO₂/CeO₂ remained greater than or equal to one. Sainz observed formation of a strongly absorbing chromophore with an absorption maximum at 290 nm when TiO₂ and CeO₂ were present in equal amounts. These coatings were reported to be highly reflective when deposited on a soda-lime glass substrate, and to exhibit an intense yellow color. A system such as this, while desirable from the standpoint of the UV absorption, could not be used in picture framing because it would impart a yellow cast to the framed artwork.

As such, a need still exists for a low cost, non-laminated, antireflective, UV blocking glass product having good cosmetic appearance and mechanically stable surfaces.

### BRIEF SUMMARY OF THE INVENTION

Applicants have developed an antireflective coating on glass in which an inorganic oxide serves both as the UV absorber and as part of the antireflective system.

The present invention includes a thin film optical coating having a sol-gel derived layer of cerium oxide, silicon dioxide and at least one oxide of a transition metal of Group IIIB, Group IVB, Group VB or Group VIB of the Periodic Table. The reference to Group IIIB through Group VIB uses the notation shown in the Periodic Table in General Chemistry Principles and Modem Applications, 3 ed., Ralph H. Petrucci, 1982, ISBN 0-02-395010-2.

The invention also includes a method for producing an ultraviolet absorbing, sol-gel derived thin film optical coating on a substrate which comprises immersing the substrate in a mixture containing cerium nitrate hexahydrate, tetraethylorthosilicate, and a compound of at least one transition metal of Group IIIB, IVB, VB or VIB of the Periodic Table, withdrawing the substrate from the mixture to provide the substrate with a coating of the mixture, and heat-treating the substrate to form an oxide layer. In one embodiment, the oxide layer has a refractive index of greater than about 2.0.

The present invention includes a method for producing sol-gel derived layers composed of cerium oxide and silicon dioxide, modified with one or more transition metal oxides from Group IIIB through Group VIB of the Periodic Table, which block transmission of ultraviolet light. In one embodiment according to the present invention, the sol-gel derived layer comprises at least greater than about 85 mole percent cerium oxide, at least greater than about 3 mole percent silicon dioxide and from about 1 to about 10 mole percent of one or more transition metal oxides from Groups IIIB through Group VIB.

The invention also includes a method for producing multilayer antireflective coatings in which a cerium oxide-silicon dioxide layer, modified with one or more transition metal oxides from Group IIIB through Group VIB, blocks transmission of ultraviolet light and serves as a high refractive index layer in the anti-reflective (“AR”) system.

The invention additionally includes a method for decreasing transmission of red light through a multilayer antireflective coating by inclusion of colloidal gold to attain optimum color balance of the transmitted light. Specifically, the method comprises adding a compound of gold to a solution capable of providing a sol-gel derived layer of cerium oxide, silicon oxide, and at least one oxide of a transition metal of Group IIIB, Group IVB, Group VB or Group VIB of the Periodic Table, immersing a substrate in the solution, withdrawing the substrate from the solution, and heat treating the substrate to form the sol-gel derived layer having colloidal gold particles.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings embodiment(s) which are presently preferred. It should be understood, however, that the invention is not limited to the precise arrangements, instrumentalities, or the specific information shown. In the drawings:

FIG. 1 is a graphical representation of the relationship between the ultraviolet and visible light cutoff shift and the mole fraction of cerium oxide in a cerium oxide/silicon dioxide system;

FIG. 2 is a graphical representation of the relationship between refractive index and mole fraction of cerium oxide in a cerium oxide/silicon dioxide system;

FIG. 3 is a graphical representation of the ultraviolet and visible light cutoffs for a titanium oxide system, a cerium oxide/silicon dioxide system and a cerium oxide/titanium oxide/silicon dioxide system;

FIG. 4 is a graphical representation of the ultraviolet and visible light cutoffs for a tantalum oxide system, a cerium oxide/silicon dioxide system and a cerium oxide/tantalum oxide/silicon dioxide system.

FIG. 5 is a graphical representation of percentage of light reflected versus the wavelength of the reflected light for the three layer anti-reflective, ultraviolet absorbing coating exemplified in Example 5; and

FIG. 6 is a graphical representation of the percentage of ultraviolet and visible light transmitted versus the wavelength of the transmitted light for the three layer anti-reflective, ultraviolet absorbing coating exemplified in Example 5.

### DETAILED DESCRIPTION OF THE INVENTION

The present invention relates to thin film optical coatings with reduced visible light reflection and with ultraviolet blocking properties. The present invention more particularly relates to sol-gel derived, anti-reflective, ultraviolet blocking, multi-layer coatings which include cerium oxide, silicon dioxide, and one or more transition metal oxides. The transition metal oxide may be derived from transition metals of Group IIIB, Group IVB, Group VB and/or Group VIB of the Periodic Table. Preferably, the transition metal is titanium, tantalum, niobium, chromium, molybdenum and/or tungsten. In a preferred embodiment, the transition metal is tantalum. Also in a preferred embodiment, the sol-gel derived layer comprises at least about 85 mol % of the cerium oxide, at least about 3 mol % of the silicon dioxide, and from about 1 to 10 mol % of the transition metal oxide. However, these concentrations could be varied by experimentation by one skilled in the art to achieve a sol-gel derived layer with specifically desired properties. The coatings also optionally include colloidal gold particles, which, in a preferred embodiment, are formed during the firing of a coating which was produced from a mixture containing hydrogen tetrachloroaurate. In a preferred embodiment, the sol-gel derived layer has a refractive index of at least about 1.90.

The present invention also relates to a process for producing a multi-layer coating which is preferably antireflective and which has a thin film optical coating with reduced light reflection and ultraviolet properties using a sol-gel process. This multi-layer antireflective optical coating may result in decreased transmission of red light through the coating. Specifically, in a preferred embodiment, the coating may transmit less than about 10% of light having a wavelength of below about 380 nm.

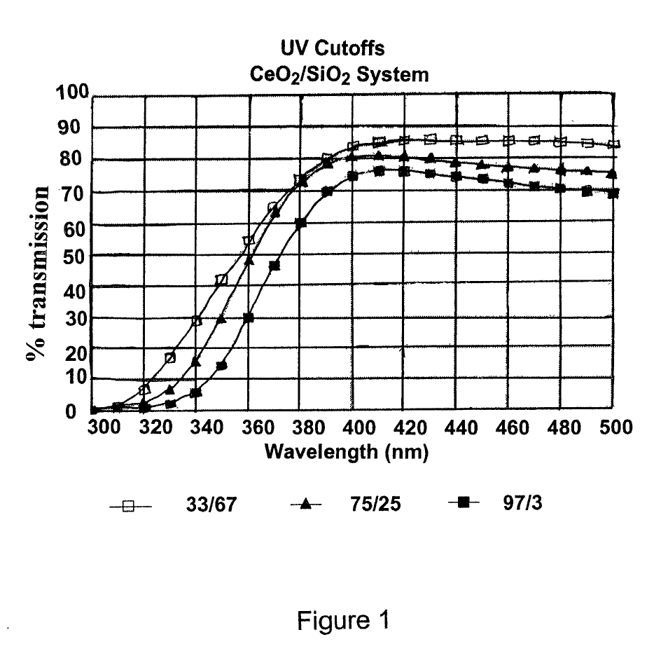

In the present invention a series of CeO₂—SiO₂ solutions has been prepared and the UV blocking property of the resulting films was measured as a function of mole percent CeO₂. The results are shown in FIG. 1. As can be seen from this diagram, the position of the UV cutoff shifts to longer wavelengths with increasing CeO₂ concentration, as expected. These were ethanol-based solutions in which the CeO₂ precursor was cerium (III) nitrate hexahydrate and the SiO₂ precursor was tetraethylorthosilicate (TEOS). The range of concentrations of CeO₂ possible was from 0 to 97.4 mole percent.

Solutions for the CeO₂—SiO₂ studies were prepared as follows. A solution was made by dissolving cerium (III) nitrate hexahydrate in ethanol such that the concentration of cerium (III) nitrate hexahydrate was about 350 g/l. A second solution was made with TEOS in ethanol such that the equivalent concentration of SiO₂ was from about 10 g/l to about 30 g/l. These two solutions were mixed in different proportions to vary the concentration of CeO₂. In each case, a mixture of cerium nitrate solution and a TEOS solution as noted above was treated with about 2-5% (by volume) 2,4-pentanedione and allowed to age at room temperature for at least about one week before use. The addition of the chelating agent and the inclusion of the aging step are preferred for production of clear films from these cerium containing solutions. However, it will be understood, based on this disclosure, that other similar solutions such as, but not limited to tetramethoxysilane (TMOS), tetra-n-butoxysilane and tetra-n-propoxysilane for forming silicon oxides may also be used within the scope of the invention. Further, it will be understood, based on this disclosure, that the order of addition of the components to the various solutions need not be made in any particular order, that the effects of the invention may also be achieved by aging for shorter or longer periods of time other than the preferred times specified herein, and that aging may be accelerated by increasing temperatures.

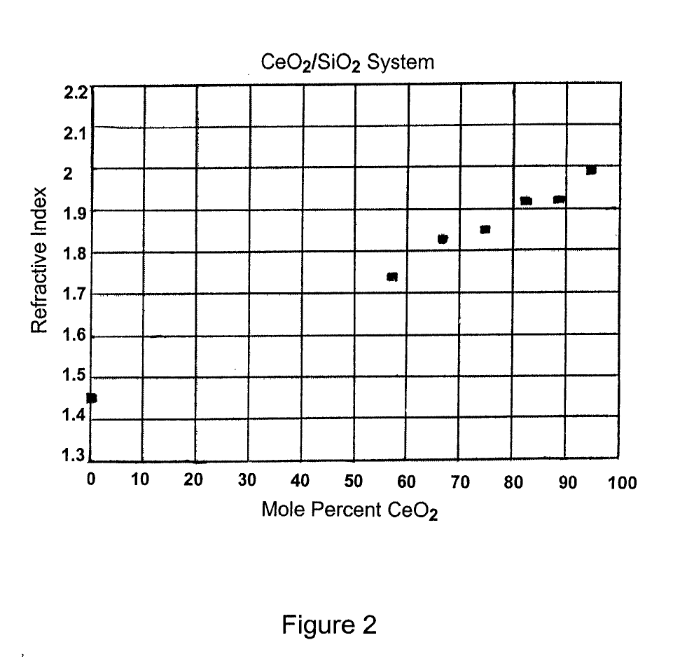

FIG. 2 is a plot of the refractive index of films produced from CeO₂—SiO₂ solutions as a function of mole percent CeO₂. The refractive index in this system is a linear function of the CeO₂ concentration and at high cerium concentrations, the films have refractive indices which make them suitable for use as high index layers in thin film optical systems. It is known and expected that combinations of two materials with differing indices of refraction will produce a material-mixture which has an index of refraction that is linearly and directly proportional to the molar ratio of the two components.

The ideal material for UV blocking in picture framing applications would be one in which all light of wavelength shorter than 400 nm would be blocked and all light of wavelength greater than 400 nm would be transmitted. Such a material would give 100% UV blocking, and since it would absorb none of the visible blue light, it would not impart any yellow appearance to the framed art. From FIG. 1 it can be seen that at a quarterwave optical thickness of 650 nm (which for a material having a refractive index of 2.00 would represent a physical thickness of about 80 nm) even a layer having a CeO₂ concentration of 97.4 mole percent blocks only about 82% of the UV when applied to a piece of 2 mm soda-lime float glass. Since existing products are available which block up to 97% of the UV (although they have other drawbacks), a UV absorption of about 90% from 300-380 nm is considered preferable for a viable UV blocking product.

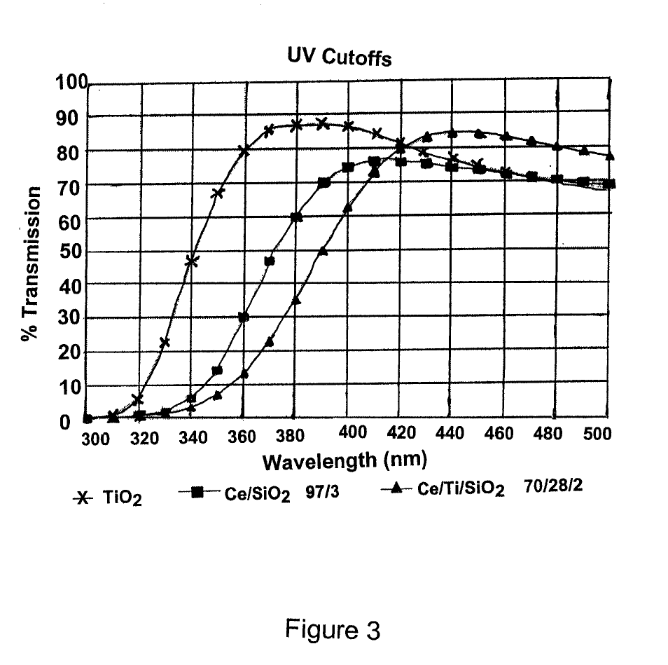

Titanium oxide, which is also known to absorb in the UV, while transmitting visible light, is even less effective than a cerium oxide/silicon dioxide system, as shown in FIG. 3. A 650 nm quarterwave optical thickness layer of TiO₂ on 2 mm soda lime float glass blocks only about 56% of the UV from 300-380 nm, while the uncoated glass itself blocks 41%.

As Sainz, et. al., have reported, UV absorption is strongly enhanced when CeO₂ and TiO₂ are used in equimolar concentrations, but the films produced have an intense yellow color. TiO₂, in combination with CeO₂ at concentrations of TiO₂ of less than 50 mole percent, will still enhance the UV absorption but without causing as much yellowing. In FIG. 3 the UV cutoffs for TiO₂, a combination of CeO₂ and SiO₂ and a combination of CeO₂, TiO₂ and SiO₂ are compared. As FIG. 3 clearly shows, the increased UV absorption comes at the expense of significant loss of visible blue light, which results in a film that is somewhat yellow in transmission. Although this system can be used as a UV absorbing layer, for UV blocking picture framing glass a sharper UV cutoff is desirable.

In concentrations of 1 to 10 mole percent, neither of the other Group IV B oxides (zirconium or hafnium) results in any significant shift in the CeO₂ cutoff. Of the other oxides in Groups IIIB, IVB, VB, and VIB, niobium increases UV absorption the most strongly, but like titanium it tends to block too far into the visible, yielding a coating that appears yellow. The transition metal oxide having the steepest UV cutoff when used in conjunction with cerium oxide was found to be that of tantalum. This cutoff can be shifted to slightly longer wavelengths by addition of small (1-2 mole %) amounts of either TiO₂ or Nb₂O₅.

Precursor compounds used for the transition metal oxides within the invention are preferably, but not limited to compounds such as nitrates, chlorides or alkoxides, although chlorides have been demonstrated by applicants to be the preferred precursors in most cases. The addition of chelating and stabilizing agents such as, for example, diketones, glycols and glycol monoethers is preferred for production of films of good optical quality. Specifically, in addition to the 2,4-pentanedione used in the CeO₂—SiO₂ solutions, chelating and stabilizing agents such as 1,2-propanediol, 1,3-propanediol, ethylene glycol, and propylene glycol monomethyl ether are most preferred. Concentrations of chelating or stabilizing agents used ranged from about 1 to about 15 volume %, with the preferred range being from about 9 to about 12 volume % of total stabilizing agents.

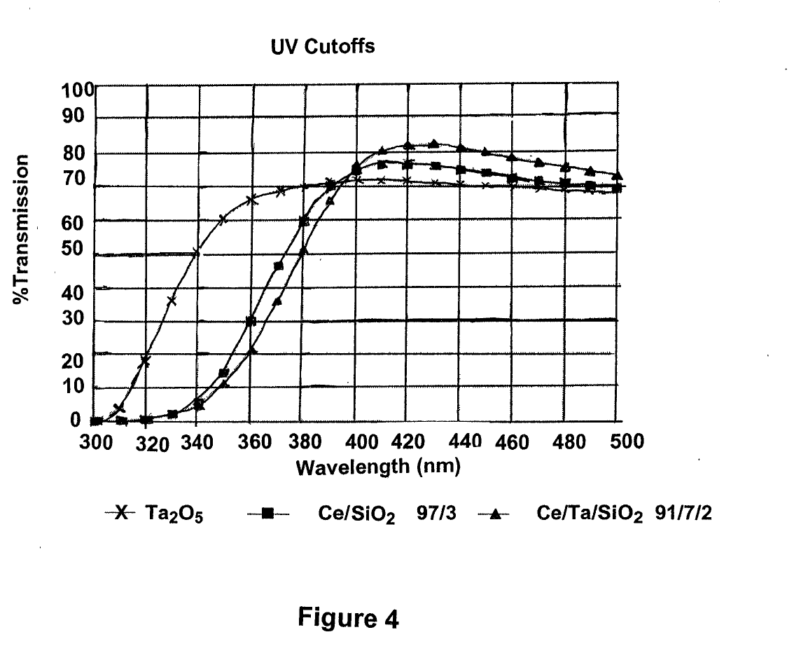

In FIG. 4, the UV cutoffs of CeO₂, Ta₂O₅, and the combination of CeO₂ and Ta₂O₅ are shown. As is the case with CeO₂ and TiO₂, the combination of CeO₂ and Ta₂O₅ gives rise to a chromophore that absorbs strongly in the UV, but absorption does not extend as far into the visible region. Addition of the Ta₂O₅ has the added benefit of increasing the refractive index of the film from 1.99 to 2.03, which is more favorable for use in the formation of a three-layer low reflection coating.

Although the CeO₂—Ta₂O₅ system absorbs less visible blue light than the CeO₂—TiO₂ system, it may still absorb enough to give a slight yellow color to transmitted light, particularly if the CeO₂—Ta₂O₅ cutoff has been shifted to longer wavelengths by addition of small amounts of either TiO₂ or Nb₂O₅. This has been corrected in the anti-reflective layer system by the incorporation of hydrogen tetrachloroaurate in the high index layer. Concentrations ranging from about 0.210 to about 0.375 g/l have been used. During the firing of the coating system, this material decomposes with the formation of colloidal gold particles. These particles cause slight scattering of light of longer wavelengths, resulting in preferential transmission in the blue. This compensates for the loss of transmission of visible blue light by absorption of the UV chromophores.

Immersion of the substrate can be accomplished in a variety of ways. The particular manner in which the substrate is immersed is in no way critical to the present invention. Immersion can be accomplished by automated or manual means. It should also be understood that with respect to the present invention, immersion can mean both “full” immersion of the substrate into the mixture, as well as the partial immersion of the substrate into the mixture. The substrate is then withdrawn from the mixture, whereby the substrate is provided with a coating of the mixture. The duration of immersion is not critical and may vary. The coating remains on both sides of the surface of the substrate. The film begins to thin due to evaporation of the alcohol. Alternatively, spin-coating methods may be used. As the evaporation occurs, there is a buffer zone of alcohol vapor above the surface of the coating film closer to the dipping solution. As the substrate moves away from the dipping solution, the vapor buffer decreases exposing the coating solution to atmospheric moisture and increasing the rate of reaction.

Acid can further catalyze the reaction. As the concentration of acid increases due to the evaporation of alcohol, the pH will begin to decrease. The chemical reactions are complex and their mechanisms are not fully understood. However, it is believed that the overall reaction rate is catalyzed by the changing (i.e., increasing) concentrations of reactive components, the evaporation of alcohol and the increase in water concentration as described above. The reactions occur in the zone extending longitudinally along the substrate surface as the alcohol is at least partially evaporated.

The substrate is preferably withdrawn from the mixture at a rate of from about 2 mm/s to about 20 mm/s. More preferably, the substrate is withdrawn from the mixture at a rate of from about 6 mm/s to about 12 mm/s. Withdrawal rate is known to affect coating thickness, as explained by H. Schroeder, “Oxide Layers Deposited from Organic Solutions”, Physics of Thin Films, Vol. 5, pp. 87-141, (1969), (hereinafter referred to as “Schroeder”), the entire contents of which are incorporated herein by reference. While the rate at which the substrate is withdrawn is not absolutely critical, the ranges discussed above are generally preferred. It should be understood, however, that any rate could be used in accordance with the present invention in order to vary the resulting thickness, as desired. Also, as discussed in Schroeder, the angle at which the substrate is withdrawn has an effect on the coating thickness and uniformity. According to the present invention, it is preferable that the substrate is withdrawn from the solution such that the longitudinal axis of the substrate is approximately at a 90° angle with the surface of the mixture. While this withdrawal angle is preferable in order to provide even coatings to both sides of the substrate, it should be understood that the present invention may be practiced using any withdrawal angle.

Once the substrate has been withdrawn from the mixture, it may be subjected to intermediate heat-treatments, additional coating processes, and or final cure heat-treatments. The terms “heat-treatment” and “heat-treating” are understood to include either intermediate heating steps or final cure heating steps, or both, unless specified.

Intermediate heat-treating includes heating a substrate at a temperature from about 75° C. to about 200° C. for a period up to about one hour, more preferably from about 5 to about 10 minutes, in order to remove excess fluid. Fluids that may be contained within the coating present on the substrate can include, for example, water, alcohol(s), and acid(s). Final cure heat-treating includes heating a substrate at a temperature of up to about 450° C. Final cure heat-treating times (“soak times”) can range from zero to about twenty-four hours, with the preferred soak time being from about 0.5 to about 2.0 hours. Following heat treatment, the oxide layer has a refractive index of greater than about 2.0 in a preferred embodiment.

According to the method of the present invention, an H solution can be prepared which provides a sol-gel derived coating comprising cerium oxide, tantalum oxide, titanium oxide, silicon dioxide and colloidal gold such that the coating has a refractive index greater than about 2.0 and blocks greater than about 90% of the UV between 300 and 380 nm.

Additionally, the present invention also includes a method for producing a UV-absorbing, sol-gel derived thin film optical coating containing an M layer. Such a method may include immersing an oxide-coated substrate into an M solution comprising, for example, tetraethylorthosilicate and the reaction product of titanium chloride and ethanol, withdrawing the substrate from the M solution to provide the substrate with a coating of the M solution, and drying the substrate to form a silicon dioxide and titanium dioxide layer having a refractive index of about 1.80. During the subsequent preparation of the UV absorbing H layer solution, chelating or stabilizing agents may also be added, such as those previously described. The preparation of the H layer solution may thus involve, for example, aging a precursor solution comprising tetraethylorthosilicate, cerium nitrate hexahydrate, ethanol and a chelating agent.

According to the present invention, a multi-layer, UV-absorbing, sol-gel derived, anti-reflective thin film optical coating containing an L layer may be produced by immersing an oxide-coated substrate containing an H layer into an L solution comprising, for example, tetraethylorthosilicate, ethanol and water, withdrawing the substrate from the L solution to provide the substrate with a coating of the L solution, and heat-treating the substrate to form an oxide layer having a refractive index of about 1.45.

Finally, a multi-layer anti-reflective, UV absorbing thin film optical coating having an M/H/L structure may be produced according to the present invention by coating a substrate with (1) an M solution followed by heat-treatment, (2) an H solution followed by heat treatment, and (3) an L solution followed by heat treatment.

The invention will now be described based on the following non-limiting examples:

### EXAMPLE 1

A UV absorbing, H-layer solution was formed from cerium (III) nitrate hexahydrate, tantalum chloride, titanium chloride and tetraethylorthosilicate as follows:

(1) 350 g of cerium (III) nitrate hexahydrate were dissolved in 700 ml of ethanol. The solution was diluted to a final volume of 1000 ml with ethanol.

(2) 203 g of tantalum chloride were reacted by slow addition of tantalum chloride to 800 ml of ethanol with constant stirring. After the addition was complete, the solution was diluted to a final volume of 1000 ml with ethanol.

(3) 180 ml of titanium chloride were reacted by slow addition (under argon) of 380 ml of ethanol with constant stirring. After the addition was complete, the solution was diluted to a final volume of 1000 ml with ethanol.

(4) 277 ml tetraethylorthosilicate, 600 ml ethanol, 55 ml deionized water, and 4 ml HCl (37%) were mixed. The solution was diluted to a final volume of 1000 ml.

(5) The following ingredients were mixed in the order shown, however, as noted above, the order of combination is not critical.

| | | |
|---|---|---|
| Ethanol | 610 | ml |
| Solution (4) | 9.1 | ml |
| Solution (1) | 210 | ml |
| 2,4-Pentanedione | 25.6 | ml |

The solution was covered and held for one week at room temperature. However, as noted above, the effects of the invention are also achievable by aging for a different period of time. Higher temperatures are also within the scope of the invention which may accelerate aging.

After aging, the following additions were made but need not be added in any particular order:

| | | |
|---|---|---|
| Propylene glycol monomethyl ether | 94 | ml |
| Solution (2) | 42.8 | ml |
| Solution (3) | 8.5 | ml |
| Hydrogen tetrachloroaurate | 0.281 | g |

This solution formed a coating having a refractive index of 2.07. A layer having a quarterwave optical thickness of 800 nm, deposited on 2 mm soda-lime float glass, was found to block 92% of the UV between 300 and 380 nm.

### EXAMPLE 2

A UV absorbing, H-layer solution was formed as in Example 1. Steps (1) to (4) were identical to those described in Example 1.

(5) The following ingredients were mixed in the order shown, however, as noted above, the order of combination is not critical.

| | | |
|---|---|---|
| Ethanol | 404 | ml |
| Solution (4) | 26.5 | ml |
| Solution (1) | 307.1 | ml |
| 2,4-Pentanedione | 37.5 | ml |

The solution was covered and held for one week at room temperature. However, as noted above, the effects of the invention are also achievable by aging for a different period of time. Higher temperatures are also within the scope of the invention which may accelerate aging.

After aging, the following additions were made but need not be added in any particular order:

| | | |
|---|---|---|
| Propylene glycol monomethyl ether | 124.9 | ml |
| Solution (2) | 62.5 | ml |
| Solution (3) | 25.0 | ml |
| 1,2-Propanediol | 12.5 | ml |
| Hydrogen tetrachloroaurate | 0.281 | g |

This solution formed a coating having a refractive index of 2.07. A layer having a quarterwave optical thickness of 800 nm, deposited on 2 mm soda-lime float glass, was found to block 92% of the UV between 300 and 380 nm.

### EXAMPLE 3

An L-layer solution was formed by mixing 119 ml ethanol, 67 ml TEOS, 40 ml deionized water, and 1 ml HCl (37%) with stirring at room temperature. During stirring at room temperature, the viscosity was measured every hour. When the viscosity reached a value of 3.0-3.2 centistokes the solution was diluted to a final volume of 1000 ml with ethanol. This solution formed a coating having a refractive index of 1.45.

### EXAMPLE 4

An M layer solution was formed as follows:

(1) 277 ml tetraethylorthosilicate, 600 ml ethanol, 55 ml deionized water, and 4 ml HCl (37%) were mixed. The solution was diluted to a final volume of 1000 ml.

(2) 180 ml of titanium chloride were reacted by slow addition (under argon) of 380 ml of ethanol with constant stirring. After the addition was complete, the solution was diluted to a final volume of 1000 ml with ethanol.

(3) 86 ml of Solution (1) of this Example were mixed with 79 ml of Solution (2) of this Example and then diluted with ethanol to a final volume of 1000 ml.

This solution formed a coating having a refractive index of 1.80.

### EXAMPLE 5

A three-layer anti-reflective, UV absorbing coating was applied to both sides of a 2 mm thick piece of soda-lime float glass, using the M solution described in Example 4, the UV absorbing H solution described in Example 1, and the L solution described in Example 3. A cleaned piece of glass was first dipped in the M solution and withdrawn vertically at a rate of 6.4 mm/sec. The glass was subsequently dried in an oven for 6 minutes at 170° C. After the glass cooled to room temperature, it was dipped into the H solution and withdrawn vertically from that solution at a rate of 7.5 mm/sec.

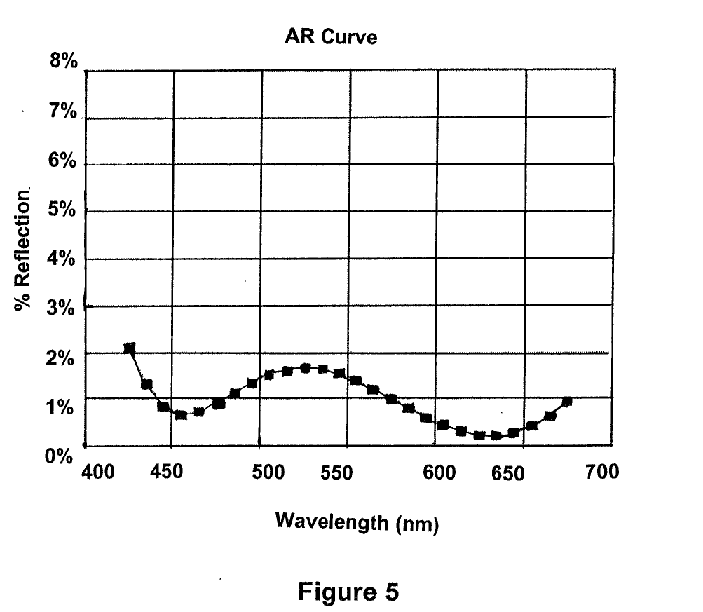

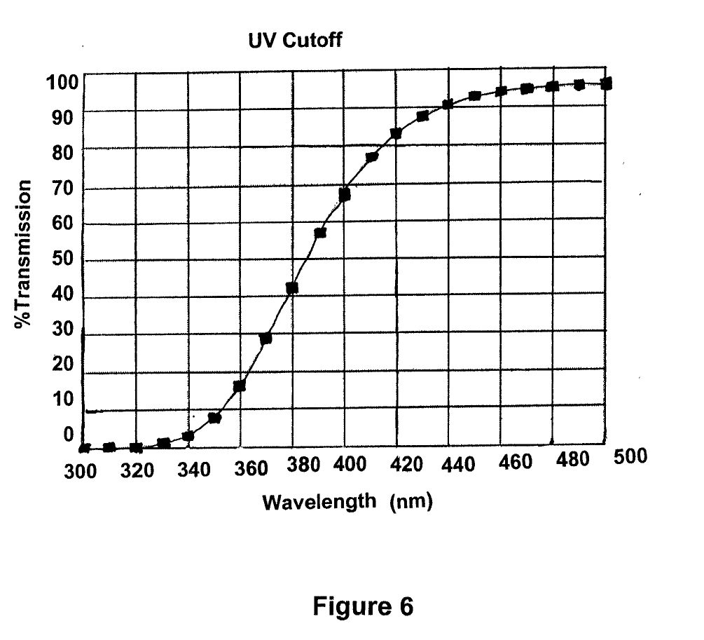

The glass was then heated in a furnace to a temperature of 430° C. in 2 hours, held at 430° C. for 1 hour, and finally cooled slowly (over 3 hours) to room temperature. After cooling, the glass was dipped in the L solution and withdrawn vertically at a rate of 8.0 mm/sec. The glass was again heated in a furnace to 430° C., following the same heating and cooling profile as before. Reflectivity of the coated glass sample was measured, at normal incidence, over the range 425 to 675 nm, and the average reflection was found to be 0.96%. Transmission was measured over the range 300 to 450 nm, and the sample was found to block 89.7% of the UV in the 300-380 nm region. These results are shown graphically in FIGS. 5 and 6.

As can be seen from the above data, the particular systems and techniques of the present invention provide a low cost, sol-gel derived, antireflective, UV-blocking glass product having good cosmetic appearance and mechanically stable surfaces. In one embodiment, the invention provides a method for altering the transmission of visible light through a multi-layer antireflective coating by the novel inclusion of colloidal gold to attain optimal color balance of transmitted light. Such a coating may be applicable to glass to be used for picture framing by reducing the degree of yellow cast imparted to framed artwork by the UV-absorbing layer.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

We claim:

1. A thin film optical coating having a sol-gel derived layer of cerium oxide, silicon dioxide and at least one oxide of a transition metal of Group IIIB, Group IVB, Group VB or Group VIB of the Periodic Table.

2. The coating according to claim 1, wherein the transition metal oxide is tantalum oxide.

3. The coating according to claim 1, wherein the sol-gel derived layer has a refractive index of at least about 1.90.

4. The coating in accordance with claim 1, wherein the sol-gel derived layer comprises at least about 85 mole percent of the cerium oxide, at least about 3 mole percent of the silicon dioxide, and from about 1 to about 10 mole percent of the at least one oxide of a transition metal.

5. The coating in accordance with claim 1, wherein the layer transmits less than about 10 percent of light having a wavelength of below about 380 nm.

6. The coating according to claim 1, wherein the oxide of the at least one transition metal is selected from the group consisting of oxides of titanium, tantalum, niobium, chromium, molybdenum, and tungsten.

7. The coating according to claim 1, wherein the sol-gel derived layer further comprises colloidal gold particles.

8. A method for producing an ultraviolet absorbing sol-gel derived thin film optical coating on a substrate comprising:
(a) immersing the substrate in a mixture comprising cerium nitrate hexahydrate, tetraethylorthosilicate, and a compound of at least one transition metal of Group IIIB, Group IVB, Group VB, or Group VIB of the Periodic Table;
(b) withdrawing the substrate from the mixture to provide the substrate with a coating of the mixture; and
(c) heat-treating the substrate to form an oxide layer.

9. The method according to claim 8, wherein the oxide layer has a refractive index of greater than about 2.0.

10. The method of production according to claim 8, wherein the mixture further comprises a compound of tantalum.

11. The method of production according to claim 8, wherein the mixture further comprises hydrogen tetrachloroaurate.

12. The method of production according to claim 8, wherein the oxide layer further comprises colloidal gold particles.

13. The method of production according to claim 8, wherein the mixture further comprises a chelating agent.

14. The method of production according to claim 13, wherein the chelating agent is selected from the group consisting of diketones, glycols and glycol monoethers.

15. The method of production according to claim 14, wherein the chelating agent is selected from the group consisting of 2, 4-pentadione, 1,2-propanediol, 1,3-propanediol, ethlyene glycol and propylene glycol monomethyl ether.

16. The method of production according to claim 13, wherein the concentration of the chelating agent in the mixture ranges from about 1 volume percent to about 15 volume percent.

17. The method of production according to claim 16, wherein the chelating agent in the mixture ranges from about 9 volume percent to about 12 volume percent.

18. The method of production according to claim 8, further comprising:
(a) immersing the substrate in an M solution comprising tetraethylorthosilicate and the reaction product of titanium chloride and ethanol;
(b) withdrawing the substrate from the M solution to provide the substrate with a coating of the M solution; and
(c) drying the substrate to form a silicon dioxide and titanium dioxide layer having a refractive index of about 1.80.

19. The method of production according to claim 18, further comprising:
(a) immersing the substrate in an L solution comprising tetraethylorthosilicate, ethanol and water;
(b) withdrawing the substrate from the L solution to provide the substrate with a coating of the L solution; and
(c) heat-treating the substrate to form an oxide layer having a refractive index of about 1.45 to form the optical coating, wherein the optical coating is anti-reflective.

20. A method of decreasing transmission of red light through a multilayer anti-reflective optical coating comprising:
(a) adding a compound of gold to a solution capable of providing a sol-gel derived layer of cerium oxide, silicon oxide, and at least one oxide of a transition metal of Group IIIB, Group IVB, Group VB, and Group VIB of the Periodic Table.
(b) immersing a substrate in the solution;
(c) withdrawing the substrate from the solution; and
(d) heat treating the substrate to form the sol-gel derived layer having colloidal gold particles.

21. The method according to claim 20 wherein the colloidal gold particles are formed from hydrogen tetrachloroaurate.
